(19) United States
(12) Patent Application Publication
(10) Pub. No.: US 2025/0046009 A1
(43) Pub. Date: Feb. 6, 2025

(54) Display Method For Three-Dimensional House Model, Terminal, And Storage Medium

(71) Applicant: BEIJING YOUZHUJU NETWORK TECHNOLOGY CO., LTD., Beijing (CN)

(72) Inventor: Yang DONG, Beijing (CN)

(21) Appl. No.: 18/720,269

(22) PCT Filed: Mar. 13, 2023
(86) PCT No.: PCT/CN2023/081076

§ 371 Date: Jun. 14, 2024

(30) Foreign Application Priority Data
Mar. 22, 2022 (CN) 202210281178.2

(51) Int. Cl. G06T 15/20; G06F 3/147

(52) U.S. Cl. CPC G06T 15/20; G06F 3/147

(57) ABSTRACT

A display method and apparatus for a three-dimensional house model, a terminal, and a storage medium are disclosed. The display method includes: establishing N virtual objects in the three-dimensional house model, in which the N virtual objects correspond to N terminals; configuring an observation viewpoint for each virtual object among the N virtual objects, in which the observation viewpoint is capable of moving with the each virtual object; loading N virtual scenes through a corresponding observation viewpoint according to position information of the each virtual object among the N virtual objects in the three-dimensional house model; and sending the N virtual scenes to the N terminals to enable the N terminals to display the N virtual scenes respectively, in which a virtual scene includes at least one another virtual object, in addition to a virtual object corresponding to a terminal, among the N virtual objects.

### CROSS-REFERENCE TO RELATED APPLICATION

The present application claims the priority to Chinese Patent Application No. 202210281178.2, filed on Mar. 22, 2022, the entire disclosure of which is incorporated herein by reference as portion of the present application.

### TECHNICAL FIELD

Embodiments of the present disclosure relate to a display method and apparatus for a three-dimensional house model, a terminal, and a storage medium.

### BACKGROUND

Virtual reality is a technology to simulate a virtual environment to bring people a sense of environmental immersion. In the related art, in house viewing by VR, it may only be viewed by one user with a single perspective, and cannot meet the need for multiple persons to view a house model at the same time.

### SUMMARY

An object of the embodiments of the present disclosure is to provide a display method and apparatus for a three-dimensional house model, a terminal, and a storage medium, realizing an effect of multiple users viewing a three-dimensional house model from independent perspectives.

In a first aspect, the embodiments of the present disclosure provide a display method for a three-dimensional house model, which is applied to a server, and the display method includes: establishing N virtual objects in the three-dimensional house model, in which the N virtual objects correspond to N terminals; configuring an observation viewpoint for each virtual object among the N virtual objects, in which the observation viewpoint is capable of moving with the each virtual object; loading N virtual scenes through a corresponding observation viewpoint according to position information of the each virtual object among the N virtual objects in the three-dimensional house model; and sending the N virtual scenes to the N terminals to enable the N terminals to display the N virtual scenes respectively, in which a virtual scene includes at least one another virtual object, in addition to a virtual object corresponding to a terminal, among the N virtual objects.

In a second aspect, the embodiments of the present disclosure provide a display method for a three-dimensional house model, which is applied to a terminal, and the display method includes: receiving a virtual scene from a server, in which the virtual scene is obtained by loading through a corresponding observation viewpoint according to position information of a virtual object, corresponding to the terminal, among the N virtual objects in the three-dimensional house model; and displaying the virtual scene, in which the virtual scene includes at least one another virtual object, in addition to the virtual object corresponding to the terminal, among the N virtual objects.

In a third aspect, the embodiments of the present disclosure provide a display apparatus for a three-dimensional house model, which is applied to a server, and the display apparatus includes: a modeling module, configured to establish N virtual objects in the three-dimensional house model, in which the N virtual objects correspond to N terminals; a configuration module, configured to configure an observation viewpoint for each virtual object among the N virtual objects, in which the observation viewpoint is capable of moving with the each virtual object; a loading module, configured to load N virtual scenes through a corresponding observation viewpoint according to position information of the each virtual object among the N virtual objects in the three-dimensional house model; and a first sending module, configured to send the N virtual scenes to the N terminals to enable the N terminals to display the N virtual scenes respectively, in which a virtual scene includes at least one another virtual object, in addition to a virtual object corresponding to a terminal, among the N virtual objects.

In a fourth aspect, the embodiments of the present disclosure provide a display apparatus for a three-dimensional house model, which is applied to a terminal, and the display apparatus includes: a first receiving module, configured to receive a virtual scene from a server, in which the virtual scene is obtained by loading through a corresponding observation viewpoint according to position information of a virtual object, corresponding to the terminal, among N virtual objects in the three-dimensional house model; and a display module, configured to display the virtual scene, in which the virtual scene includes at least one another virtual object, in addition to the virtual object corresponding to the terminal, among the N virtual objects.

In a fifth aspect, the embodiments of the present disclosure provide a terminal, and the terminal includes a processor and a memory; the memory is configured to store a program or instructions that can be run on the processor, and the program or instructions, when executed by the processor, implement steps of the display method for a three-dimensional house model according to the second aspect.

In a sixth aspect, the embodiments of the present disclosure provide a readable storage medium, which stores a program or instructions, and the program or instructions, when executed by a processor, implement steps of the display method for a three-dimensional house model according to the first aspect, and/or steps of the display method for a three-dimensional house model according to the second aspect.

In the embodiments of the present disclosure, the three-dimensional house model is configured in a server, and the terminal is capable of viewing the three-dimensional house model by accessing the server. In the case that multiple terminals request to access the three-dimensional house model in the server, by the server, all the multiple terminals are accessed to the three-dimensional house model, and virtual objects corresponding to the multiple terminals one by one are established in the three-dimensional house model. An observation viewpoint of each terminal on the three-dimensional house model is configured to a corresponding virtual object. A virtual scene received by each terminal is loaded by the server. In the loading process, the virtual scene of the three-dimensional house model is loaded according to the position of each virtual object in the three-dimensional house model and the observation viewpoint; and after the loading process is completed, the loaded virtual scene is sent to the corresponding terminal for display in accordance with a corresponding relationship. In the process of loading the virtual scene, not only a house scene in the three-dimensional house model is loaded, but also other virtual objects within the field of view of the observation viewpoint are loaded, so that the virtual scene displayed in the terminal includes the virtual object.

In the embodiments of the present disclosure, by configuring multiple virtual objects corresponding to multiple terminals in the three-dimensional house model and configuring a separate observation viewpoint for each virtual object, for each terminal, the virtual scene in the three-dimensional house model may be viewed from an independent perspective, and positions of the other objects in the three-dimensional house model may also be viewed, thus realizing the effect of multiple users viewing the three-dimensional house model from independent perspectives.

### BRIEF DESCRIPTION OF DRAWINGS

FIG. 1 shows a first schematic flowchart of a display method for a three-dimensional house model provided by the embodiments of the present disclosure;

FIG. 2 shows a second schematic flowchart of a display method for a three-dimensional house model provided by the embodiments of the present disclosure;

FIG. 3 shows a third schematic flowchart of a display method for a three-dimensional house model provided by the embodiments of the present disclosure;

FIG. 4 shows a fourth schematic flowchart of a display method for a three-dimensional house model provided by the embodiments of the present disclosure;

FIG. 5 shows a fifth schematic flowchart of a display method for a three-dimensional house model provided by the embodiments of the present disclosure;

FIG. 6 shows a sixth schematic flowchart of a display method for a three-dimensional house model provided by the embodiments of the present disclosure;

FIG. 7 shows a structural block diagram of a display apparatus for a three-dimensional house model provided by the embodiments of the present disclosure;

FIG. 8 shows a structural block diagram of a display apparatus for a three-dimensional house model provided by the embodiments of the present disclosure;

FIG. 9 shows a structural block diagram of a terminal provided by the embodiments of the present disclosure; and

FIG. 10 shows a schematic diagram of a hardware structure of a terminal provided by the embodiments of the present disclosure.

### DETAILED DESCRIPTION

The following will clearly describe the embodiments of the present disclosure in conjunction with the drawings in the embodiments of the present disclosure. Apparently, the described embodiments are just a part but not all of the embodiments of the present disclosure. All other embodiments obtained by those of ordinary skill in the art based on the embodiments of the present disclosure fall within the protection scope of the present disclosure.

The terms “first”, “second”, etc. in the specification and claims of the present disclosure are used to distinguish similar objects and are not used to describe a particular order or sequence. It should be understood that the terms so used are interchangeable under appropriate cases, so that the embodiments of the present application may be implemented in an order other than those illustrated or described herein, and that the objects distinguished by the terms “first,” “second,” etc. are generally of one type and the number of the objects is not limited. For example, the number of a first object may be one or N. In addition, “and/or” in the specification and the claims indicates at least one of the connected objects, and the character “/” generally indicates that the related objects are in an “or” relationship.

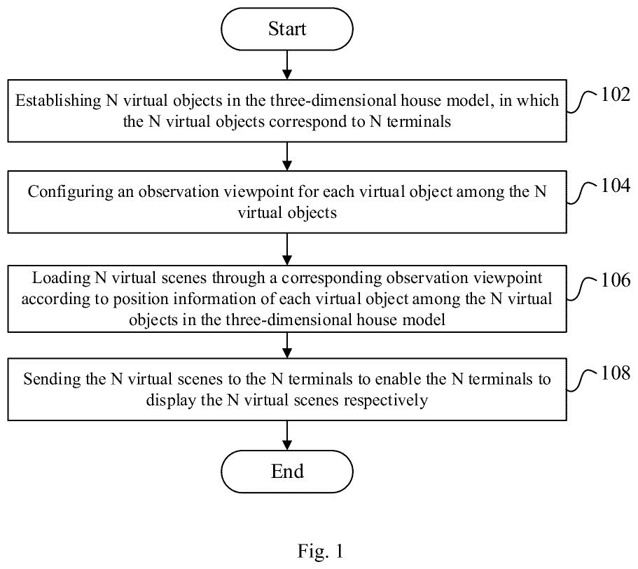

A display method for a three-dimensional house model, a display apparatus for a three-dimensional house model, a terminal, and a readable storage medium provided by the embodiments of the present disclosure are described in detail below through specific embodiments and application scenarios thereof with reference to FIGS. 1 to 10.

The embodiments of the present disclosure provide a display method for a three-dimensional house model. FIG. 1 shows a first schematic flowchart of a display method for a three-dimensional house model provided by the embodiments of the present disclosure. As shown in FIG. 1, the display method for a three-dimensional house model is applied to a server, and the display method includes the following steps.

Step 102: establishing N virtual objects in the three-dimensional house model, in which the N virtual objects correspond to N terminals.

In the case that the server receives requests to view the house from N terminals, the server establishes, in the three-dimensional house model, the same number of virtual objects as the number of the terminals that send the requests. Each virtual object corresponds to one terminal, and the virtual object can be controlled by the corresponding terminal to move in the three-dimensional house model.

It is worth noting that the N virtual objects have different identifiers respectively, and each identifier is associated with the virtual object, ensuring that identities of different virtual objects can be checked during the process of viewing the three-dimensional house model configured with the virtual objects.

Step 104: configuring an observation viewpoint for each virtual object among the N virtual objects.

The observation viewpoint is capable of moving with the virtual object.

It is worth noting that one observation viewpoint is configured for each virtual object after the N virtual objects corresponding to the N terminals are configured to the three-dimensional house model. The virtual objects can be controlled to move in the three-dimensional house model. During the movement of the virtual objects, the observation viewpoints move in the three-dimensional house model with the virtual objects.

Step 106: loading N virtual scenes through a corresponding observation viewpoint according to position information of each virtual object among the N virtual objects in the three-dimensional house model.

Step 108: sending the N virtual scenes to the N terminals to enable the N terminals to display the N virtual scenes respectively.

For a virtual scene corresponding to a terminal among the N terminals, the virtual scene includes at least one another virtual object, in addition to a virtual object corresponding to the terminal, among the N virtual objects.

This embodiment provides a solution for multiple users to view the same three-dimensional house model at the same time, allowing the multiple users to be able to not only view a scene of the house, but also observe positions of other users in the house.

In the embodiments of the present disclosure, the three-dimensional house model is configured in a server, and the terminal is capable of viewing the three-dimensional house model by accessing the server. In the case that multiple terminals request to access the three-dimensional house model in the server, by the server, all the multiple terminals are accessed to the three-dimensional house model, and virtual objects corresponding to the multiple terminals one by one are established in the three-dimensional house model. An observation viewpoint of each terminal on the three-dimensional house model is configured to a corresponding virtual object. A virtual scene received by each terminal is loaded by the server. In the loading process, the virtual scene of the three-dimensional house model is loaded according to the position of each virtual object in the three-dimensional house model and the observation viewpoint; and after the loading process is completed, the loaded virtual scene is sent to the corresponding terminal for display in accordance with a corresponding relationship. In the process of loading the virtual scene, not only a house scene in the three-dimensional house model is loaded, but also other virtual objects within the field of view of the observation viewpoint are loaded, so that the virtual scene displayed in the terminal includes the virtual object.

It is worth noting that the terminal can control the movement of the corresponding virtual object in the three-dimensional house model, and can further control the adjustment of the direction of the field of view of the observation viewpoint configured on the virtual object.

For example, when a real estate agent introduces a house online, the real estate agent and a house viewing user access a three-dimensional house model in a server via different terminals respectively. The server configures different virtual objects in the three-dimensional house model for the real estate agent and the house viewing user. The terminals of the house viewing user and the real estate agent can display virtual scenes from independent perspectives.

In the embodiments of the present disclosure, by configuring multiple virtual objects corresponding to multiple terminals in the three-dimensional house model and configuring a separate observation viewpoint for each virtual object, for each terminal, the virtual scene in the three-dimensional house model may be viewed from an independent perspective, and positions of the other objects in the three-dimensional house model may also be viewed, thus realizing the effect of multiple users viewing the three-dimensional house model from independent perspectives.

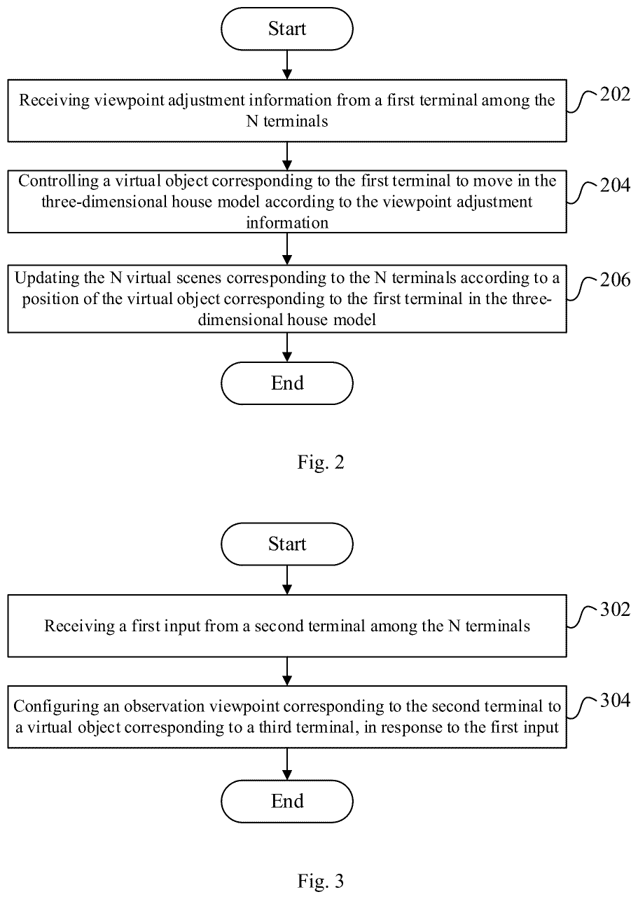

In some embodiments of the present disclosure, FIG. 2 shows a second schematic flowchart of a display method for a three-dimensional house model provided by the embodiments of the present disclosure. As shown in FIG. 2, after sending the N virtual scenes to the N terminals, the display method further includes the following steps.

Step 202: receiving viewpoint adjustment information from a first terminal among the N terminals.

It is worth noting that the first terminal is any one of the N terminals.

Step 204: controlling a virtual object corresponding to the first terminal to move in the three-dimensional house model according to the viewpoint adjustment information.

Step 206: updating the N virtual scenes corresponding to the N terminals according to a position of the virtual object corresponding to the first terminal in the three-dimensional house model.

This embodiment provides a solution for the user to control the movement of a virtual object and view the corresponding virtual scene.

In the embodiments of the present disclosure, viewpoint adjustment information from any one of the N terminals (the first terminal) is received by the server. The position of the virtual object corresponding to the first terminal is adjusted according to the viewpoint adjustment information, and after the position adjustment of the virtual object is completed, the virtual scenes displayed on the N terminals are updated according to the position of the virtual object corresponding to the first terminal in the three-dimensional house model.

Specifically, the viewpoint adjustment information includes endpoint information and perspective adjustment information of the observation viewpoint. The virtual object is controlled to move to a corresponding position in the three-dimensional house model according to the endpoint information. The observation viewpoint moves with the movement of the virtual object. After the virtual object moves to the corresponding position, the server rotates the direction of the field of view of the observation viewpoint configured on the virtual object according to the perspective adjustment information. In the process of moving the virtual object, the server transmits a virtual scene corresponding to the observation viewpoint to the first terminal for display. Because the virtual object corresponding to the first terminal moves in three-dimensional scenes of the house, virtual scenes displayed in other terminals, including the virtual object corresponding to the first terminal, are also updated.

For example, user A, user B, and user C view a virtual scene of a three-dimensional house model at the same time. If the user A controls a corresponding virtual object A to move, a virtual scene displayed on a terminal of the user A is updated according to a movement trajectory of the virtual object A and an observation viewpoint of the virtual object A. Moreover, because the virtual object A is displayed in the virtual scene of the user B, a virtual scene displayed in a terminal of the user B is updated.

In the embodiments of the present disclosure, the user can send viewpoint adjustment information to the server via a device to adjust the corresponding virtual object to move in the three-dimensional house model, and to update the virtual scene displayed on the terminal. Moreover, other users may also observe the moving virtual object, thus improving the sense of immersion and reality of multiple users viewing the same three-dimensional house model.

In some embodiments of the present disclosure, FIG. 3 shows a third schematic flowchart of a display method for a three-dimensional house model provided by the embodiments of the present disclosure. As shown in FIG. 3, after sending the N virtual scenes to the N terminals, the display method further includes the following steps.

Step 302: receiving a first input from a second terminal among the N terminals.

It is worth noting that the second terminal is any one of the N terminals. The first input is used for instructing to bind an observation viewpoint corresponding to the second terminal to an observation viewpoint of a third terminal.

Step 304: configuring an observation viewpoint corresponding to the second terminal to a virtual object corresponding to a third terminal, in response to the first input.

The third terminal is any one of the N terminals other than the second terminal.

This embodiment provides a solution for binding the observation viewpoints of multiple users, enabling the users to choose to follow the observation viewpoints of other users to view the three-dimensional house model, thus realizing the effect of multiple users viewing the three-dimensional house model from the same perspective.

In the embodiments of the present disclosure, after receiving the first input from any of the N terminals (the second terminal), the server can determine, based on the first input, an object (the third terminal) that the observation viewpoint of the second terminal follows. After determining the second terminal and the third terminal of which the viewpoints need to be bound according to the first input, the server configures the observation viewpoint of the second terminal on the virtual object corresponding to the third terminal. In the case that the third terminal controls the corresponding virtual object to move, the virtual object can drive the observation viewpoints of the third terminal and the second terminal to move, so as to update the virtual scenes displayed on the second terminal and the third terminal.

It is worth noting that the user may also send a request to the server via a terminal to request other users to follow him or her. Specifically, the server receives a second input from the second terminal, and in response to the second input, the server configures the observation viewpoint of the third terminal to the virtual object corresponding to the second terminal.

For example, during a process of the real estate agent and the house viewing user accessing the server via different terminals to view the three-dimensional house model, the real estate agent, before starting the explanation, sends a second input to the server via the corresponding first terminal; and the server, in response to the second input, binds an observation viewpoint of the house viewing user to the virtual object corresponding to the first terminal. The real estate agent can adjust the observation viewpoint of the house viewing user by controlling the movement of the virtual object corresponding to the first terminal, so as to update the virtual scene displayed on the terminal corresponding to the house viewing user, avoiding the problem of poor listening effect due to the fact that the house viewing user cannot adjust the observation viewpoint in real time in the course of explanation of the real estate agent.

In the embodiments of the present disclosure, the server can respond to the request for binding the observation viewpoints sent by the terminal to bind multiple observation viewpoints to the same virtual object, thus realizing the effect of multiple users viewing the three-dimensional house model with the same viewpoint.

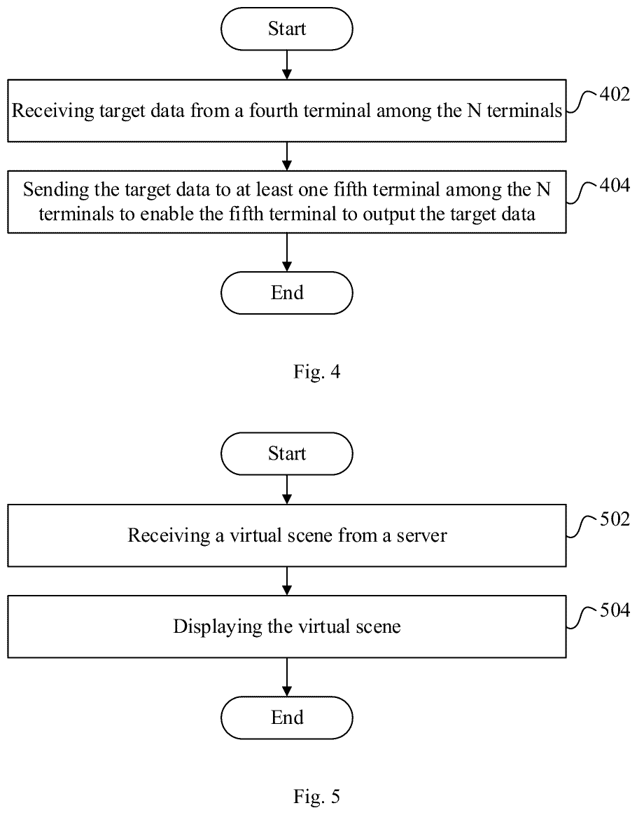

In some embodiments of the present disclosure, FIG. 4 shows a fourth schematic flowchart of a display method for a three-dimensional house model provided by the embodiments of the present disclosure. As shown in FIG. 4, the display method further includes the following steps.

Step 402: receiving target data from a fourth terminal among the N terminals.

Step 404: sending the target data to at least one fifth terminal among the N terminals to enable the fifth terminal to output the target data.

The fifth terminal is a terminal among the N terminals other than the fourth terminal.

The target data includes one or a combination of audio data and video data.

This embodiment provides a solution in which any user can broadcast and send audio data and/or video data during a process of multiple users viewing the three-dimensional house model at the same time.

In the embodiments of the present disclosure, in the case that the server receives the target data from any one of the N terminals (the fourth terminal), the server forwards the target data to a terminal (the fifth terminal) among the N terminals other than the fourth terminal, thus realizing the effect of broadcasting the target data sent from the fourth terminal.

When the fourth terminal sends the target data, it is possible to select a receiver object of the target data. Specifically, the server receives a third input from the fourth terminal, where the third input includes the target data; and according to the third input, the fifth terminal among the N terminals is determined, and the target data is sent to the fifth terminal.

For example, in the process of multiple users viewing the three-dimensional house model, if user A needs to communicate with user B by voice, then the server is able to directionally transmit an audio sent by the user A to a terminal of the user B. If the user A needs to broadcast by voice to all other users, the server is able to transmit the audio sent by the user A to terminals of all other users.

The server in the embodiments of the present disclosure is able to forward and broadcast the audio data or video data sent by the user, realizing data interaction and communication between multiple users when the multiple users viewing the three-dimensional house model.

The embodiments of the present disclosure further provide a display method for a three-dimensional house model. FIG. 5 shows a fifth schematic flowchart of a display method for a three-dimensional house model provided by the embodiments of the present disclosure. As shown in FIG. 5, the display method for a three-dimensional house model is used for a terminal, the number of terminals is N, the three-dimensional house model is configured with N virtual objects corresponding to the N terminals, and the display method includes the following steps.

Step 502: receiving a virtual scene from a server.

The virtual scene is obtained by loading through a corresponding observation viewpoint according to position information of a virtual object, corresponding to the terminal, among the N virtual objects in the three-dimensional house model.

Step 504: displaying the virtual scene.

The virtual scene includes at least one another virtual object, in addition to the virtual object corresponding to the terminal, among the N virtual objects.

This embodiment provides a solution for the user to view the three-dimensional house model stored in a server.

In the embodiments of the present disclosure, the three-dimensional house model is configured in the server, and the terminal is able to view the three-dimensional house model by accessing the server. After the terminal sends a request for viewing the three-dimensional house model to the server, the terminal receives a virtual scene returned from the server and displays the virtual scene.

If there are multiple terminals, by the server, all the multiple terminals are accessed to the three-dimensional house model, and virtual objects corresponding to the multiple terminals one by one are established in the three-dimensional house model. An observation viewpoint of each terminal on the three-dimensional house model is configured to a corresponding virtual object. The virtual scene received by each terminal is loaded by the server. In the loading process, the virtual scene of the three-dimensional house model is loaded according to the position of each virtual object in the three-dimensional house model and the observation viewpoint; and after the loading is completed, the loaded virtual scene is sent to the corresponding terminal for display in accordance with a corresponding relationship. In the process of loading the virtual scene, not only a house scene in the three-dimensional house model is loaded, but also other virtual objects within the field of view of the observation viewpoint are loaded, so that the virtual scene displayed on the terminal includes the virtual objects.

In the embodiments of the present disclosure, by configuring multiple virtual objects corresponding to multiple terminals in the three-dimensional house model and configuring a separate observation viewpoint for each virtual object, for each terminal, the virtual scene in the three-dimensional house model may be viewed from an independent perspective, and positions of the other objects in the three-dimensional house model may also be viewed, thus realizing the effect of multiple users viewing the three-dimensional house model from independent perspectives.

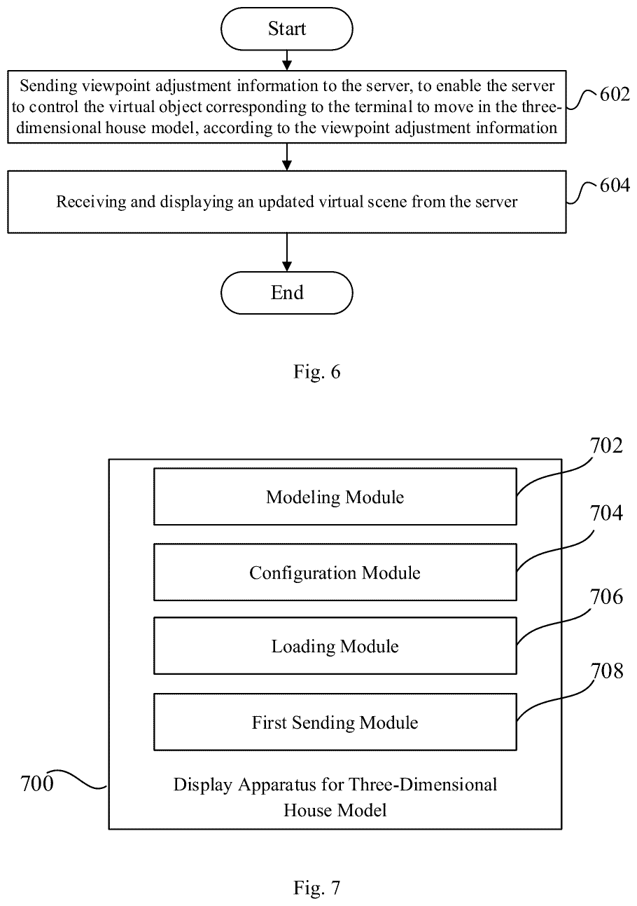

In some embodiments of the present disclosure, FIG. 6 shows a sixth schematic flowchart of a display method for a three-dimensional house model provided by the embodiments of the present disclosure. As shown in FIG. 6, after displaying the virtual scene, the display method further includes the following steps.

Step 602: sending viewpoint adjustment information to the server, to enable the server to control the virtual object corresponding to the terminal to move in the three-dimensional house model, according to the viewpoint adjustment information.

Step 604: receiving and displaying an updated virtual scene from the server.

This embodiment provides a solution for the user to control the movement of a virtual object and view the corresponding virtual scene.

In the embodiments of the present disclosure, the terminal sends the viewpoint adjustment information to the server, enabling the server to adjust the position of the virtual object corresponding to the first terminal according to the viewpoint adjustment information. After the position adjustment of the virtual object is completed, the virtual scene displayed on the terminal is updated according to the position of the virtual object corresponding to the terminal in the three-dimensional house model.

The number of the terminals is N, and a first terminal among the N terminals sends the viewpoint adjustment information. Specifically, the viewpoint adjustment information includes endpoint information and perspective adjustment information of the observation viewpoint. The virtual object is controlled to move to a corresponding position in the three-dimensional house model according to the endpoint information. The observation viewpoint moves with the movement of the virtual object. After the virtual object moves to the corresponding position, the server rotates the direction of the field of view of the observation viewpoint configured on the virtual object according to the perspective adjustment information. In the process of moving the virtual object, the server transmits a virtual scene corresponding to the observation viewpoint to the first terminal for display. Because the virtual object corresponding to the first terminal moves in the three-dimensional scene of the house, virtual scenes displayed in other terminals, including the virtual object corresponding to the first terminal, are also updated.

In the embodiments of the present disclosure, the user can send viewpoint adjustment information to the server via a device to adjust the corresponding virtual object to move in the three-dimensional house model, and to update the virtual scene displayed on the terminal. Moreover, other users may also observe the moving virtual object, thus improving the sense of immersion and reality of multiple users viewing the same three-dimensional house model.

In some embodiments of the present disclosure, after displaying the virtual scene, the method further includes:
sending a first input to the server to enable the server to bind an observation viewpoint of the terminal to a virtual object, corresponding to a target terminal, among the N terminals.

This embodiment provides a solution for binding the observation viewpoints of multiple users, enabling the users to choose to follow the observation viewpoints of other users to view the three-dimensional house model, thus realizing the effect of multiple users viewing the three-dimensional house model from the same perspective.

In the embodiments of the present disclosure, the terminal sends the first input to the server, and the first input is used for instructing to bind an observation viewpoint corresponding to the second terminal to an observation viewpoint of a target terminal. After receiving the first input from the terminal, the server, based on the first input, is able to determine an object (the target terminal) that the observation viewpoint of the terminal follows. After determining the terminal and the target terminal of which the viewpoints need to be bound according to the first input, the server configures the observation viewpoint of the terminal on the virtual object corresponding to the target terminal. In the case that the target terminal controls the corresponding virtual object to move, the virtual object can drive the observation viewpoints of the terminal and the target terminal to move, so as to update the virtual scenes displayed on the terminal and the target terminal.

It is worth noting that the user may also send a request to the server via the terminal to request other users to follow him or her. Specifically, the second input is sent to the server to enable the server to bind the observation viewpoint of the target terminal among the N terminals to the virtual object corresponding to the terminal.

In the embodiments of the present disclosure, the server can respond to the request for binding the observation viewpoints sent by the terminal to bind multiple observation viewpoints to the same virtual object, thus realizing the effect of multiple users viewing the three-dimensional house model with the same viewpoint.

In some embodiments of the present disclosure, after displaying the virtual scene, the display method further includes:
sending target data to the server, to enable the server to forward the target data to at least one another terminal among the N terminals, and to enable the at least one another terminal to output the target data.

The target data includes one or a combination of audio data and video data.

This embodiment provides a solution in which any user can broadcast and send audio data and/or video data during a process of multiple users viewing the three-dimensional house model at the same time.

In the embodiments of the present disclosure, the terminal sends target data to the server; if the server receives the target data from the terminal, the server forwards the target data to another terminal among the N terminals other than the fourth terminal, realizing the effect of broadcasting the target data sent from the fourth terminal.

When the terminal sends the target data, it is possible to select a receiver object of the target data.

For example, in the process of multiple users viewing the three-dimensional house model, if user A needs to communicate with user B by voice, then the server is able to directionally transmit an audio sent by the user A to a terminal of the user B. If the user A needs to broadcast by voice to all other users, the server is able to transmit the audio sent by the user A to terminals of all other users.

The server in the embodiments of the present disclosure is able to forward and broadcast the audio data or video data sent by the user, realizing data interaction and communication between multiple users when the multiple users viewing the three-dimensional house model.

The display method for a three-dimensional house model provided by the embodiments of the present disclosure may be executed by a display apparatus for a three-dimensional house model. In the embodiments of the present disclosure, the display apparatus for a three-dimensional house model provided by the embodiments of the present disclosure is described by taking the display method executed by the display apparatus for a three-dimensional house model as an example.

In some embodiments of the present disclosure, a display apparatus for a three-dimensional house model is provided. FIG. 7 shows a structural block diagram of a display apparatus for a three-dimensional house model provided by the embodiments of the present disclosure. As shown in FIG. 7, the display apparatus 700 for a three-dimensional house model includes a modeling module 702, a configuration module 704, a loading module 706, and a first sending module 708.

The modeling module 702 is configured to establish N virtual objects in the three-dimensional house model, and the N virtual objects correspond to N terminals.

In the case that the server receives requests to view the house from N terminals, the server establishes, in the three-dimensional house model, the same number of virtual objects as the number of the terminals that send the requests. Each virtual object corresponds to one terminal, and the virtual object can be controlled by the corresponding terminal to move in the three-dimensional house model.

It is worth noting that the N virtual objects have different identifiers respectively, and each identifier is associated with the virtual object, ensuring that identities of different virtual objects can be checked during the process of viewing the three-dimensional house model configured with the virtual objects.

The configuration module 704 is configured to configure an observation viewpoint for each virtual object among the N virtual objects.

The loading module 706 is configured to load N virtual scenes through a corresponding observation viewpoint according to position information of each virtual object among the N virtual objects in the three-dimensional house model.

The first sending module 708 is configured to send the N virtual scenes to the N terminals to enable the N terminals to display the N virtual scenes respectively, and each virtual scene includes at least one another virtual object, in addition to a virtual object corresponding to the terminal, among the N virtual objects.

In the embodiments of the present disclosure, by configuring multiple virtual objects corresponding to multiple terminals in the three-dimensional house model and configuring a separate observation viewpoint for each virtual object, for each terminal, the virtual scene in the three-dimensional house model may be viewed from an independent perspective, and positions of the other objects in the three-dimensional house model may also be viewed, thus realizing the effect of multiple users viewing the three-dimensional house model from independent perspectives.

In some embodiments of the present disclosure, the display apparatus 700 for a three-dimensional house model further includes a second receiving module, a control module, and an updating module.

The second receiving module is configured to receive viewpoint adjustment information from a first terminal among the N terminals.

The control module is configured to control a virtual object corresponding to the first terminal to move in the three-dimensional house model according to the viewpoint adjustment information.

The updating module is configured to update the N virtual scenes corresponding to the N terminals according to a position of the virtual object corresponding to the first terminal in the three-dimensional house model.

In the embodiments of the present disclosure, the user can send viewpoint adjustment information to the server via a device to adjust the corresponding virtual object to move in the three-dimensional house model, and to update the virtual scene displayed on the terminal. Moreover, other users may also observe the moving virtual object, thus improving the sense of immersion and reality of multiple users viewing the same three-dimensional house model.

In some embodiments of the present disclosure, the second receiving module is further configured to receive a first input from a second terminal among the N terminals.

The configuration module 704 is further configured to configure an observation viewpoint corresponding to the second terminal to a virtual object corresponding to a third terminal, in response to the first input.

The third terminal is any one of the N terminals other than the second terminal.

In the embodiments of the present disclosure, the server can respond to the request for binding the observation viewpoints sent by the terminal to bind multiple observation viewpoints to the same virtual object, thus realizing the effect of multiple users viewing the three-dimensional house model with the same viewpoint.

In some embodiments of the present disclosure, the second receiving module is further configured to receive target data from a fourth terminal among the N terminals.

The first sending module 708 is further configured to send the target data to at least one fifth terminal among the N terminals to enable the fifth terminal to output the target data.

The fifth terminal is a terminal among the N terminals other than the fourth terminal.

The target data includes one or a combination of audio data and video data.

The server in the embodiments of the present disclosure is able to forward and broadcast the audio data or video data sent by the user, realizing data interaction and communication between multiple users when the multiple users viewing the three-dimensional house model.

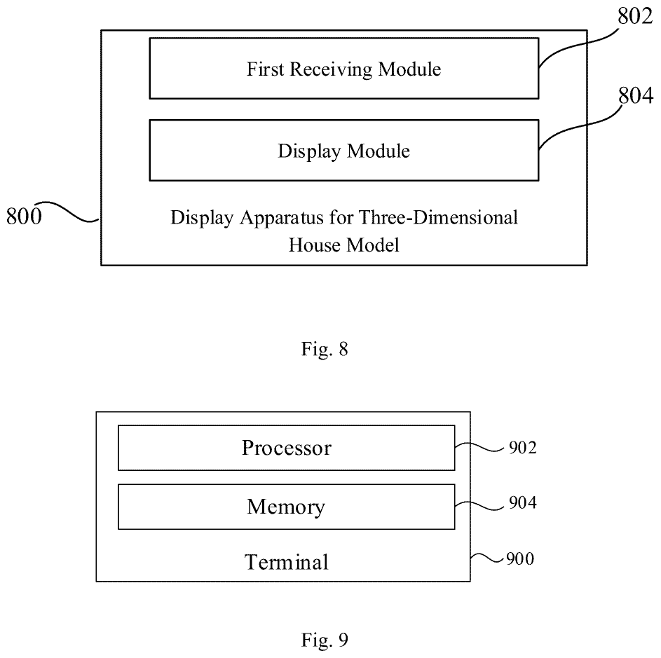

Some embodiments of the present disclosure provide a display apparatus for a three-dimensional house model. FIG. 8 shows a structural block diagram of a display apparatus for a three-dimensional house model provided by the embodiments of the present disclosure. As shown in FIG. 8, the display apparatus for a three-dimensional house model is used for a buyer terminal, and the display apparatus 800 for a three-dimensional house model includes a first receiving module 802 and a display module 804.

The first receiving module 802 is configured to receive a virtual scene from a server.

The virtual scene is obtained by loading through a corresponding observation viewpoint according to position information of a virtual object, corresponding to the terminal, among N virtual objects in the three-dimensional house model.

The display module 804 is configured to display the virtual scene.

The virtual scene includes at least one another virtual object, in addition to the virtual object corresponding to the terminal, among the N virtual objects.

In the embodiments of the present disclosure, by configuring multiple virtual objects corresponding to multiple terminals in the three-dimensional house model and configuring a separate observation viewpoint for each virtual object, for each terminal, the virtual scene in the three-dimensional house model may be viewed from an independent perspective, and positions of the other objects in the three-dimensional house model may also be viewed, thus realizing the effect of multiple users viewing the three-dimensional house model from independent perspectives.

In some embodiments of the present disclosure, the display device 800 for a three-dimensional house model further includes a second sending module and a first receiving module 802.

The second sending module is configured to send viewpoint adjustment information to the server, to enable the server to control the virtual object corresponding to the terminal to move in the three-dimensional house model, according to the viewpoint adjustment information.

The first receiving module 802 is configured to receive an updated virtual scene from the server.

The display module 804 is further configured to display the updated virtual scene.

In the embodiments of the present disclosure, the user can send viewpoint adjustment information to the server via a device to adjust the corresponding virtual object to move in the three-dimensional house model, and to update the virtual scene displayed on the terminal. Moreover, other users may also observe the moving virtual object, thus improving the sense of immersion and reality of multiple users viewing the same three-dimensional house model.

In some embodiments of the present disclosure, the second sending module is further configured to send a first input to the server to enable the server to bind an observation viewpoint of the terminal to a virtual object, corresponding to a target terminal, among the N terminals.

In the embodiments of the present disclosure, the server can respond to the request for binding the observation viewpoint sent by the terminal to bind multiple observation viewpoints to the same virtual object, thus realizing the effect of multiple users viewing the three-dimensional house model with the same viewpoint.

In some embodiments of the present disclosure, the second sending module is further configured to send target data to the server, to enable the server to forward the target data to at least one another terminal among the N terminals, and to enable the at least one another terminal to output the target data.

The server in the embodiments of the present disclosure is able to forward and broadcast the audio data or video data sent by the user, realizing data interaction and communication between multiple users when the multiple users viewing the three-dimensional house model.

The display apparatus for a three-dimensional house model in the embodiments of the present disclosure may be an electronic device, or a component in an electronic device, such as an integrated circuit or a chip. The electronic device may be a terminal or a device other than the terminal. For example, the electronic device may be a cell phone, a tablet computer, a laptop computer, a palmtop computer, a vehicle-mounted electronic device, a Mobile Internet Device (MID), an augmented reality (AR)/virtual reality (VR) device, a robot, a wearable device, an ultra-mobile personal computer (UMPC), a netbook or a personal digital assistant (PDA), etc., and may also be a server, a Network Attached Storage (NAS), a personal computer (PC), a television (TV), a teller machine, or a self-service machine, etc., and the embodiments of the present disclosure do not impose specific limitations thereon.

The display apparatus for a three-dimensional house model in the embodiments of the present disclosure may be an apparatus having an operating system. The operating system may be an Android operating system, an iOS operating system, or other possible operating systems, and the embodiments of the present disclosure do not impose specific limitations thereon.

The display apparatus for a three-dimensional house model provided by the embodiments of the present disclosure can implement procedures implemented by the foregoing method embodiments. To avoid repetition, details are not described again herein.

Optionally, as shown in FIG. 9, the embodiments of the present disclosure further provide a terminal 900. The terminal 900 includes a processor 902 and a memory 904. A program or instructions capable of running on the processor 902 are stored in the memory 904. When the program or instructions are executed by the processor 902, the steps of the foregoing method embodiments are implemented, with the same technical effects achieved. To avoid repetition, details are not described herein again.

It should be noted that the terminal in the embodiments of the present disclosure includes a mobile electronic device and a non-mobile electronic device as described above.

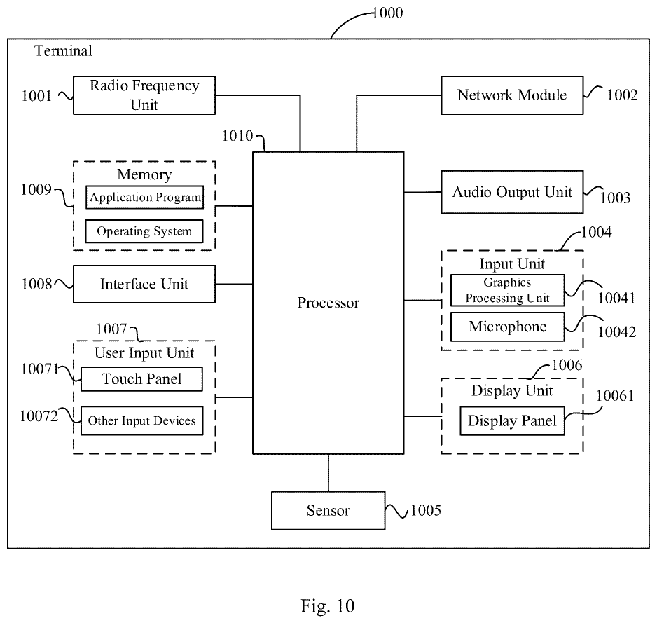

FIG. 10 is a schematic diagram of a hardware structure of a terminal according to the embodiments of the present disclosure.

The terminal 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

Those skilled in the art may understand that the terminal 1000 further includes a power supply (for example, a battery) supplying power to all components. The power supply may be logically connected to the processor 1010 through a power management system. In this way, functions such as charge management, discharge management, and power consumption management are implemented by using the power management system. The structure of the terminal shown in FIG. 10 does not constitute a limitation on the terminal. The terminal may include more or fewer components than those shown in the figure, or some components are combined, or component arrangements are different, which will not be repeated here.

The processor 1010 is configured to receive a virtual scene from a server.

The virtual scene is obtained by loading through a corresponding observation viewpoint according to position information of a virtual object, corresponding to the terminal, among the N virtual objects in the three-dimensional house model.

The display unit 1006 is configured to display the virtual scene.

The virtual scene includes at least one another virtual object, in addition to the virtual object corresponding to the terminal, among the N virtual objects.

In the embodiments of the present disclosure, by configuring multiple virtual objects corresponding to multiple terminals in the three-dimensional house model and configuring a separate observation viewpoint for each virtual object, for each terminal, the virtual scene in the three-dimensional house model may be viewed from an independent perspective, and positions of the other objects in the three-dimensional house model may also be viewed, thus realizing the effect of multiple users viewing the three-dimensional house model from independent perspectives.

Further, the processor 1010 is configured to send viewpoint adjustment information to the server, to enable the server to control the virtual object corresponding to the terminal to move in the three-dimensional house model, according to the viewpoint adjustment information.

The processor 1010 is configured to receive an updated virtual scene from the server.

In the embodiments of the present disclosure, the user can send viewpoint adjustment information to the server via a device to adjust the corresponding virtual object to move in the three-dimensional house model, and to update the virtual scene displayed on the terminal. Moreover, other users may also observe the moving virtual object, thus improving sense of immersion and reality of multiple users viewing the same three-dimensional house model.

Further, the processor 1010 is configured to send a first input to the server to enable the server to bind an observation viewpoint of the terminal to a virtual object, corresponding to a target terminal, among the N terminals.

In the embodiments of the present disclosure, the server can respond to the request for binding the observation viewpoints sent by the terminal to bind multiple observation viewpoints to the same virtual object, thus realizing the effect of multiple users viewing the three-dimensional house model with the same viewpoint.

Further, the processor 1010 is configured to send target data to the server, to enable the server to forward the target data to at least one another terminal among the N terminals, and to enable the at least one another terminal to output the target data.

The server in the embodiments of the present disclosure is able to forward and broadcast the audio data or video data sent by the user, realizing data interaction and communication between multiple users when the multiple users viewing the three-dimensional house model.

It should be understood that in the embodiments of the present disclosure, the input unit 1004 may include a graphics processing unit (GPU) 10041 and a microphone 10042, and the graphics processing unit 10041 processes image data of a still picture or a video obtained by an image capture apparatus (for example, a camera) in an image capture mode or a video capture mode. The display unit 1006 may include a display panel 10061, and the display panel 10061 may be configured in a form of a liquid crystal display, an organic light-emitting diode or the like. The user input unit 1007 includes at least one of a touch panel 10071 and other input devices 10072. The touch panel 10071 is also referred to as a touch screen. The touch panel 10071 may include two parts: a touch detection apparatus and a touch controller. The other input devices 10072 may include but are not limited to a physical keyboard, a function key (e.g., a volume control key or a power on/off key), a trackball, a mouse, a joystick, and the like. Details are not described herein.

The memory 1009 may be configured to store a software program and various data. The memory 1009 may mainly include a first storage area for storing the program or instructions and a second storage area for storing data. The first storage area may store an operating system, an application program or instructions required for at least one function (e.g., a sound play function and an image play function), and the like. In addition, the memory 1009 may include a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), or a direct rambus random access memory (DRRAM). The memory 1009 in the embodiments of the present disclosure includes but is not limited to these and any other applicable types of memories.

The processor 1010 may include one or N processing units. Optionally, the processor 1010 integrates an application processor and a modem processor. The application processor mainly processes operations involving an operating system, a user interface, an application program, and the like. The modem processor mainly processes wireless communication signals, such as a baseband processor. It may be understood that the modem processor may alternatively not be integrated into the processor 1010.

The embodiments of the present disclosure further provide a readable storage medium, and the readable storage medium stores a program or instructions. When the program or instructions are executed by a processor, the procedures of the foregoing embodiments of the display method for a three-dimensional house model are implemented, with the same technical effects achieved. To avoid repetition, details are not further described herein.

The processor is a processor in the terminal of the foregoing embodiments. The readable storage medium includes a computer-readable storage medium, such as a computer read-only memory (ROM), a random access memory (RAM), a magnetic disk, or an optical disc.

The embodiments of the present disclosure further provide a chip, including a processor and a communication interface, where the communication interface is coupled to the processor, and the processor is configured to run a program or instructions to implement the procedures of the foregoing method embodiments, with the same technical effects achieved. To avoid repetition, details are not further described herein.

It should be understood that the chip mentioned in the embodiments of the present disclosure may also be referred to as a system-level chip, a system chip, a chip system, or a System-on-Chip (SoC).

The embodiments of the present disclosure further provide a computer program product, the program product is stored in a storage medium, and the program product is executed by at least one processor to implement the procedures of the foregoing embodiments of the display method for a three-dimensional house model, with the same technical effects achieved. To avoid repetition, details are not further described herein.

It should be noted that in the present disclosure, the terms “comprise,” “comprising,” “include,” “including,” etc., or any other variant thereof are intended to cover non-exclusive inclusion, such that a process, a method, an article or an apparatus comprising a set of elements includes not only those elements, but also other elements not expressly listed, or other elements not expressly listed for the purpose of such a process, method, article or device, or elements that are inherent to such process, method, article or apparatus. Without further limitation, an element defined by the phrase “includes a . . . ” does not preclude the existence of additional identical elements in the process, method, article or apparatus that includes the element. In addition, it should be noted that the scope of the methods and apparatuses in the embodiments of the present disclosure is not limited to performing the functions in the order shown or discussed, but may also include performing the functions in a substantially synchronous manner or in a reverse order according to the functions involved, e.g., the described methods may be performed in a different order than described, and each step may be added, omitted, or combined. In addition, features described with reference to some examples may be combined in other examples.

According to the foregoing description of the implementations, those skilled in the art may clearly understand that the foregoing embodiments may be implemented by using software in combination with a necessary general-purpose hardware platform, and certainly may alternatively be implemented by using hardware. However, in most cases, the former is a preferred implementation. Based on such an understanding, the technical solutions of the present disclosure essentially, or the part contributing to the prior art may be implemented in a form of a computer software product. The computer software product is stored in a storage medium (for example, ROM/RAM, a magnetic disk, or an optical disc), and includes several instructions for instructing a terminal (which may be a mobile phone, a computer, a server, a network device, or the like) to perform the method described in the embodiments of the present disclosure.

The foregoing describes the embodiments of the present disclosure with reference to the drawings. However, the present disclosure is not limited to the foregoing specific implementations. The foregoing specific implementations are merely illustrative rather than restrictive. As instructed by the present disclosure, those of ordinary skill in the art may develop many other manners without departing from principles of the present disclosure and the protection scope of the claims, and all such manners fall within the protection scope of the present disclosure.

1. A display method for a three-dimensional house model, applied to a server, the display method comprising:
establishing N virtual objects in the three-dimensional house model, wherein the N virtual objects correspond to N terminals;
configuring an observation viewpoint for each virtual object among the N virtual objects, wherein the observation viewpoint is capable of moving with the each virtual object;
loading N virtual scenes through a corresponding observation viewpoint according to position information of the each virtual object among the N virtual objects in the three-dimensional house model; and
sending the N virtual scenes to the N terminals to enable the N terminals to display the N virtual scenes respectively, wherein for a virtual scene corresponding to a terminal among the N terminals, the virtual scene comprises at least one another virtual object, in addition to a virtual object corresponding to the terminal, among the N virtual objects.

2. The display method for a three-dimensional house model according to claim 1, wherein after the sending the N virtual scenes to the N terminals, the display method further comprises:
receiving viewpoint adjustment information from a first terminal among the N terminals;
controlling a virtual object corresponding to the first terminal to move in the three-dimensional house model according to the viewpoint adjustment information; and
updating the N virtual scenes corresponding to the N terminals according to a position of the virtual object corresponding to the first terminal in the three-dimensional house model.

3. The display method for a three-dimensional house model according to claim 1, wherein after the sending the N virtual scenes to the N terminals, the display method further comprises:
receiving a first input from a second terminal among the N terminals; and
configuring an observation viewpoint corresponding to the second terminal to a virtual object corresponding to a third terminal, in response to the first input, wherein the third terminal is any one of the N terminals other than the second terminal.

4. The display method for a three-dimensional house model according to claim 1, further comprising:
receiving target data from a fourth terminal among the N terminals; and
sending the target data to at least one fifth terminal among the N terminals to enable the fifth terminal to output the target data, wherein the fifth terminal is a terminal among the N terminals other than the fourth terminal;
wherein the target data comprises one or a combination of audio data and video data.

5. A display method for a three-dimensional house model, applied to a terminal, wherein the three-dimensional house model is configured with N virtual objects corresponding to N terminals, and the display method comprises:
receiving a virtual scene from a server, wherein the virtual scene is obtained by loading through a corresponding observation viewpoint according to position information of a virtual object, corresponding to the terminal, among the N virtual objects in the three-dimensional house model; and
displaying the virtual scene, wherein the virtual scene comprises at least one another virtual object, in addition to the virtual object corresponding to the terminal, among the N virtual objects.

6. The display method for a three-dimensional house model according to claim 5, wherein after the displaying the virtual scene, the display method further comprises:
sending viewpoint adjustment information to the server, to enable the server to control the virtual object corresponding to the terminal to move in the three-dimensional house model, according to the viewpoint adjustment information; and
receiving an updated virtual scene from the server.

7. The display method for a three-dimensional house model according to claim 5, wherein after the displaying the virtual scene, the display method further comprises:
sending a first input to the server to enable the server to bind an observation viewpoint of the terminal to a virtual object, corresponding to a target terminal, among the N terminals.

8. The display method for a three-dimensional house model according to claim 5, wherein after the displaying the virtual scene, the display method further comprises:
sending target data to the server, to enable the server to forward the target data to at least one another terminal among the N terminals, and to enable the at least one another terminal to output the target data,
wherein the target data comprises one or a combination of audio data and video data.

9. (canceled)

10. (canceled)

11. A terminal, comprising:
a memory, storing a program or instructions; and
a processor, configured to execute the program or instructions to implement a display method for a three-dimensional house model, and the display method is applied to a terminal, the three-dimensional house model is configured with N virtual objects corresponding to N terminals, and he display method comprises:
receiving a virtual scene from a server, wherein the virtual scene is obtained by loading through a corresponding observation viewpoint according to position information of a virtual object, corresponding to the terminal, among the N virtual objects in the three-dimensional house model; and
displaying the virtual scene, wherein the virtual scene comprises at least one another virtual object, in addition to the virtual object corresponding to the terminal, among the N virtual objects.

12. A readable storage medium, storing a program or instructions, wherein the program or instructions, when executed by a processor, implement the display method for a three-dimensional house model according to claim 1.

13. The display method for a three-dimensional house model according to claim 2, wherein after the sending the N virtual scenes to the N terminals, the display method further comprises:
receiving a first input from a second terminal among the N terminals; and
configuring an observation viewpoint corresponding to the second terminal to a virtual object corresponding to a third terminal, in response to the first input, wherein the third terminal is any one of the N terminals other than the second terminal.

14. The display method for a three-dimensional house model according to claim 2, further comprising:
receiving target data from a fourth terminal among the N terminals; and
sending the target data to at least one fifth terminal among the N terminals to enable the fifth terminal to output the target data, wherein the fifth terminal is a terminal among the N terminals other than the fourth terminal;
wherein the target data comprises one or a combination of audio data and video data.

15. The display method for a three-dimensional house model according to claim 3, further comprising:
receiving target data from a fourth terminal among the N terminals; and
sending the target data to at least one fifth terminal among the N terminals to enable the fifth terminal to output the target data, wherein the fifth terminal is a terminal among the N terminals other than the fourth terminal;
wherein the target data comprises one or a combination of audio data and video data.

16. The display method for a three-dimensional house model according to claim 6, wherein after the displaying the virtual scene, the display method further comprises:
sending a first input to the server to enable the server to bind an observation viewpoint of the terminal to a virtual object, corresponding to a target terminal, among the N terminals.

17. The display method for a three-dimensional house model according to claim 6, wherein after the displaying the virtual scene, the display method further comprises:
sending target data to the server, to enable the server to forward the target data to at least one another terminal among the N terminals, and to enable the at least one another terminal to output the target data,
wherein the target data comprises one or a combination of audio data and video data.

18. The display method for a three-dimensional house model according to claim 7, wherein after the displaying the virtual scene, the display method further comprises:
sending target data to the server, to enable the server to forward the target data to at least one another terminal among the N terminals, and to enable the at least one another terminal to output the target data,
wherein the target data comprises one or a combination of audio data and video data.

19. A terminal, comprising:
a memory, storing a program or instructions; and
a processor, configured to execute the program or instructions to implement the display method for a three-dimensional house model according to claim 1.

20. A terminal, comprising:
a memory, storing a program or instructions; and
a processor, configured to execute the program or instructions to implement the display method for a three-dimensional house model according to claim 2.

21. A terminal, comprising:
a memory, storing a program or instructions; and
a processor, configured to execute the program or instructions to implement the display method for a three-dimensional house model according to claim 3.

22. A readable storage medium, storing a program or instructions, wherein the program or instructions, when executed by a processor, implement the display method for a three-dimensional house model according to claim 5.
